(19) United States
(12) Patent Application Publication
(10) Pub. No.: US 2007/0104227 A1
(43) Pub. Date: May 10, 2007

(54) Distributed digital subscriber line access multiplexers and methods to operate the same

(76) Inventor: Norbert Rivera, San Antonio, TX (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/268,423

(22) Filed: Nov. 7, 2005

(51) Int. Cl. H04J 1/02

(52) U.S. Cl. 370/493

(57) ABSTRACT

Distributed digital subscriber line (DSL) access multiplexers (DSLAMs) and methods to operate the same are disclosed. An example distributed DSLAM comprises a first module comprising at least one signal processing device to process a DSL signal and a communication link to transport the DSL signal between the first module and a second module. The second module of the example distributed DSLAM comprises a plurality of analog interfaces connectable to respective ones of a plurality of lines for providing services to respective ones of a plurality of subscribers, and a switching interface to route the DSL signal between the communication link and a first one of the plurality of interfaces associated with a first one of the subscribers.

### FIELD OF THE DISCLOSURE

This disclosure relates generally to communications networks and/or systems and, more particularly, to distributed digital subscriber line access multiplexers and methods to operate the same.

### BACKGROUND

Digital subscriber line (DSL) technology is commonly utilized to provide Internet related services to subscribers, such as, for example, homes and/or businesses (also referred to herein as users and/or customers). DSL technology enables customers to utilize telephone lines (e.g., ordinary twisted-pair copper telephone lines used to provide Plain Old Telephone System (POTS) services) to connect the customer to, for example, a high data rate broadband Internet network, broadband service and/or broadband content.

Communication companies and/or service providers utilize any of a variety of communication servers and/or devices to generate, encode, transport and/or transmit broadband service content (i.e., downstream signals and/or content such as, for example, audio, video, voice, data, pictures, web pages, etc.) to a plurality of users. These communication servers and/or devices also receive and/or decode service content transmitted by the plurality of users (i.e., upstream signals and/or content). For example, a communication company and/or service provider may utilize a plurality of modems (e.g., a plurality of DSL modems) implemented by a DSL Access Multiplexer (DSLAM). A DSLAM includes many, sometimes hundreds, of individual DSL modems and/or modem modules. In general, a DSL modem receives broadband service content from, for example, a backbone server and forms a digital downstream DSL signal to be transmitted to the customer. Likewise, the DSL modem receives an upstream DSL signal from the customer and provides the data transported in the upstream DSL signal to the backbone server.

Since each DSL modem and/or modem module may be physically connected to only one telephone line at a time, each modem and/or modem module in the DSLAM will, when provisioned and/or configured, be dedicated to provide DSL services to a single user. DSLAMs may be deployed in neighborhoods and/or business districts, awaiting demand from customers (e.g., a request for a DSL service). Today, when a customer requests the communications company to provide a DSL service, such as, for example, Internet access, broadband Internet access, Voice over Internet Protocol (VoIP), video on demand (VoD) or an Internet Protocol based Television (IPTV) service, the communications company dispatches a technician to connect a particular modem and/or modem module of a DSLAM to the customer's telephone line.

Similarly, when a customer requests that a service be discontinued, or if the customer desires to switch from a first set of services (e.g., all available services) to a second set of services (e.g., a reduced set of services, a slower speed service, etc.), a technician may be sent to re-wire and/or re-provision the DSLAM, as appropriate. Alternatively or additionally, the DSL modem connected to the customer's telephone line, the DSLAM and/or backbone servers may be re-configured to reflect the second set of services.

Since many customers who request a DSL service expect that the service will be provided promptly, (e.g., frequently the same day), many communications companies have installed DSLAMs at various locations in various geographic areas. This allows the customer to be connected promptly without waiting for DSLAM equipment to be installed. However, this pre-installation of DSLAMs is operationally expensive as the pre-installed and/or deployed DSLAM resources are not effectively and/or efficiently utilized since actual demand may either substantially lag the deployment of the DSLAMs or never mature.

FIG. 1 illustrates an example prior art communication system. In the illustrated example of FIG. 1, an Operations Center 22, for example, determines that a service (e.g., Video on Demand (VoD) via DSL) is to be available in a particular neighborhood, and instructs and/or commands, for example, a Central Office 24 to provide the service to the neighborhood. The Central Office 24 may contain several communication servers and/or devices to provide a variety of services to various customers (e.g., plain old telephone service (POTS)). The example Central Office 24 of FIG. 1 may, for example, provide a DSL service via a Feeder One (F1) cable 25 that connects the Central Office 24 to a particular DSL modem in a DSL access multiplexer (DSLAM) (not shown in FIG. 1) located at a Serving Area Interface (SAI) 26. In the example of FIG. 1, a Distribution Cable (F2) pair 27 connects the DSL modem to a Serving Terminal 28. Finally, a drop cable pair 32 (i.e., a telephone line) connects the Serving Terminal 28 to a customer 30. In the example system of FIG. 1, DSLAMs may, additionally or alternatively, be located within the Central Office 24 and/or the Serving Terminal 28. Further, the example system of FIG. 1 may deploy DSLAMs in different locations to serve different subscribers.

When the customer 30 requests a service (e.g., VoD via DSL), or requests that a service be discontinued, a service order is created and a technician 34 is dispatched from, for example, a garage 36 to (re-)provision and/or (re-)configure the DSLAM to connect a DSL modem to, or disconnect a DSL modem from, the customer 30. For example, the technician 34 may add or remove jumpers within, for example, the SAI 26 to connect a DSL modem to, or disconnect a DSL modem from, the F2 cable pair 27 and/or the F1 cable 25. The technician 34 may also be dispatched to a neighborhood to, for example, provide other adjustments that may be necessitated by a change request from a first set of services to a second set of services, to re-configure the DSLAM, to re-provision the DSLAM, to change F1 pairs out of an unmanned central office, to test and/or change an F2 pair, etc.

### BRIEF DESCRIPTION OF THE DRAWINGS

FIG. 1 is a schematic illustration of an example prior art communication system.

FIGS. 2, 3, and 4 are example manners of implementing a distributed Digital Subscriber Line (DSL) Access Multiplexer (DSLAM) constructed in accordance with the teachings of the invention.

FIG. 5 is an example manner of mapping, cross-switching and/or cross-connecting one or more analog modules to one or more signal processing modules.

FIG. 6 is another example manner of implementing a distributed DSLAM constructed in accordance the teachings of the invention.

FIGS. 7 and 8 are schematic illustrations of example communication systems constructed in accordance with of the teachings of the invention.

FIG. 9 is a flowchart representative of example machine readable instructions which may be executed to configure the example DSLAMs and/or systems of FIGS. 2-8.

FIG. 10 is a schematic illustration of an example processor platform that may be used and/or programmed to execute the example machine readable instructions represented by FIG. 9 to configure the example DSLAMs and/or systems of FIGS. 2-8.

### DETAILED DESCRIPTION

Methods and apparatus to implement a distributed digital subscriber line (DSL) access multiplexer (DSLAM) are disclosed. An disclosed example distributed DSLAM comprises a first module comprising at least one signal processing device to process a DSL signal and a communication link to transport the DSL signal between the first module and a second module. The second module of the example distributed DSLAM comprises a plurality of analog interfaces connectable to respective ones of a plurality of lines for providing services to respective ones of a plurality of subscribers. The second module also includes a switching interface to route the DSL signal between the communication link and a first one of the plurality of analog interfaces associated with a first one of the plurality of subscribers.

A disclosed example module of a distributed DSLAM comprises a signal processing device configurable to process a DSL signal to be routed to an analog interface associated with a subscriber line and a communication device to communicate the DSL signal from the signal processing device to the analog interface. The analog interface is physically separate from the module and is connected to a first end of the subscriber line that is terminated at the other end by a DSL modem Another disclosed example module of a distributed DSLAM comprises an analog interface connectable to a subscriber line for providing a DSL service to a respective subscriber, a communication device to receive a DSL signal from a second module of the distributed DSLAM that is physically separate from the module, and a switching interface to route the DSL signal between the communication device and the analog interface. The analog interface is to transmit the DSL signal on the subscriber line and to connect to a first end of the subscriber line that is terminated at the other end by a DSL modem.

In the interest of brevity and clarity, throughout the following disclosure references will be made to connecting a DSL modem and/or a communication service to a customer. It will be readily apparent to persons of ordinary skill in the art that connecting a DSL modem to a customer involves, for example, connecting the DSL modem operated by a communications company to a telephone line (i.e., subscriber line) that is connected to a second DSL modem located in, for example, a home and/or place of business owned by the customer. The second DSL modem may be further connected to another communication and/or computing device (e.g., a personal computer) that the customer operates to access a service (e.g., Internet access) via the first and second DSL modems, the telephone line and the communications company.

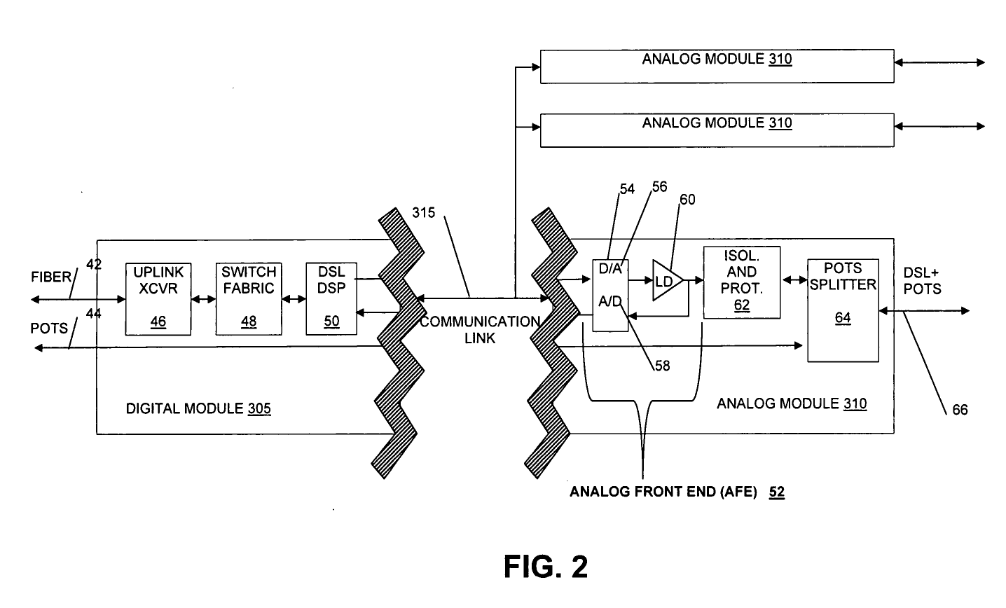

FIG. 2 illustrates an example manner of implementing a distributed DSLAM constructed in accordance with the teachings of the invention. The example distributed DSLAM of FIG. 2 is partitioned into a digital module 305 and a plurality of analog interfaces 310 (e.g., analog modules 310) to implement respective ones of a plurality of DSL modems. For ease of understanding and clarity, only a single analog interface 310 is illustrated in detail in FIG. 2. The other analog interfaces 310 are not shown in detail. However, persons of ordinary skill in the art will readily appreciate that the analog interfaces 310 of FIG. 2 are typically substantially identical. Similarly, although only three analog interfaces 310 are shown in FIG. 2, typically more than three analog interfaces 310 will be present.

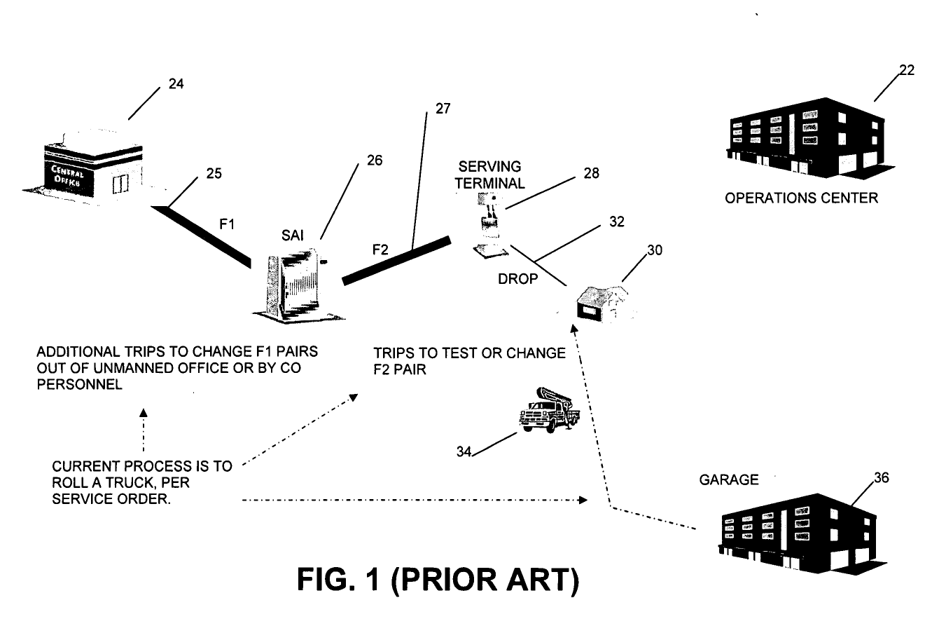

The example digital module 305 of FIG. 2 includes a fiber optic link and/or cable 42 and a POTS link 44 (e.g., comprising one or more telephone lines, the F1 cable 25 of FIG. 1, etc.). In the illustrated example of FIG. 2, the fiber optic link 42 is used to exchange digital signals with one or more broadband content servers and/or communication devices (not shown in FIG. 2). The fiber optic link 42 of the illustrated example will typically transport data associated with multiple customers to one or more of the plurality of DSL modems. To convert between the optical signals received and/or transmitted via the fiber optic link 42 and electrical signals processed by a switch fabric 48, the example digital module 305 of FIG. 2 includes an uplink transceiver 46. As used herein, the fiber optic signal and/or the electrical signals are regarded as digital signals.

To route digital signals bi-directionally between the uplink XCVR 46 and a digital signal processor (DSP) 50, the example digital module 305 of FIG. 2 includes a switch fabric 48. The switch fabric 48 switches, connects and/or routes data associated with a customer via the DSP 50 to a corresponding analog module 310 providing DSL services to that customer.

To process data and/or signals received from the switch fabric 48 and associated with a particular customer, and to generate downstream DSL signals suitable for transmitting to that customer, the example digital module 305 of FIG. 2 includes the DSP 50. For example, among other things, the DSP 50 of the illustrated example receives a block of bits from a broadband content server (e.g., a backbone server) via the uplink XCVR 46 and the switch fabric 48, applies forward error correction (FEC) to the block, creates one or more data frames from the encoded block, and modulates the frame suitably for conversion to the analog domain and transmission to the customer. Similarly, the DSP 50 of the illustrated example processes a received upstream DSL signal to determined received bits that are subsequently sent via the switch fabric 48 and the uplink XCVR 46 to, for example, the backbone server.

To convert digital downstream DSL signals generated by the DSP 50 to analog signals suitable for transmission across a telephone line to a customer, each of the example analog modules 310 include an analog front end (AFE) 52. The AFE 52 of the illustrated example also converts received analog upstream DSL signals to a digital form suitable for processing by the DSP 50. In the illustrated example of FIG. 2, the AFE 52 includes an analog/digital converter 54 and a line driver (LD) 60. As illustrated, the analog/digital converter 54 includes both a digital-to-analog converter (DAC) 56 and an analog-to-digital converter (ADC) 58. The analog/digital converter 54 may additionally contain transmit and/or receive filters.

To provide, among other things, sufficient amplification and/or filtering such that an analog signal transmitted by an analog module 310 can be correctly received by a customer (e.g., by a DSL modem situated at the customer's location), each of the example analog modules 310 of FIG. 2 include the LD 60. The LD 60 may additionally provide amplification and/or filtering to receive and/or extract an analog signal transmitted by the customer. To protect the DSLAM, the analog modules 310 and/or the digital module 304 from environmental factors (e.g., lightning, short circuits, ground faults, power induction, etc.) each of the analog modules 310 of the illustrated example include an Isolation and Protection module and/or circuit 62. In general, the Isolation and Protection module 62 limits the maximum voltage and/or current present on the end of the telephone lines closest to the analog module 310 by shunting excessive voltages and/or currents to ground. The maximum voltage and/or current is usually chosen to protect the telephone lines, the analog modules 310, the DSLAM, and/or any person who may be nearby and/or in contact with the telephone lines, the analog modules 310 and/or the DSLAM. Example shunting devices include heat coils, fuses, carbon block protectors, gas tube protectors, and solid-state protectors.

In the illustrated example of FIG. 2, the telephone line 66 that connects the analog module 310 and the customer may simultaneously carry both POTS signals (i.e., telephone service signals) and the signals transmitted and/or received by the corresponding DSL modem (i.e., DSL signals). For example, DSL signals are typically transmitted above 20 kHz (20 thousand cycles per second) and, thus, do not interfere with POTS signals (which are typically transmitted below 3 kHz). To keep transients associated with POTS (e.g., ring voltages, ring trip transients, etc.) and DSL signals from interfering, each of the example analog modules 310 of the illustrated example include a POTS splitter 64.

It will be readily apparent to persons of ordinary skill in the art that the uplink XCVR 46, the switch fabric 48 and/or the DSP 50 process data and/or signals associated with one or more DSL modems (i.e., one or more customers). In particular, as illustrated in the example distributed DSLAM of FIG. 2, the DSP 50 (i.e., the digital module 305) is connected to the plurality of analog modules 310 that are associated with respective ones of the plurality of customers. However, a separate analog module 310 (e.g., an AFE 52, a separate LD 60, separate isolation and protection 62 and a separate POTS splitter 64) are provided for each DSL modem implemented by the example distributed DSLAM of FIG. 2.

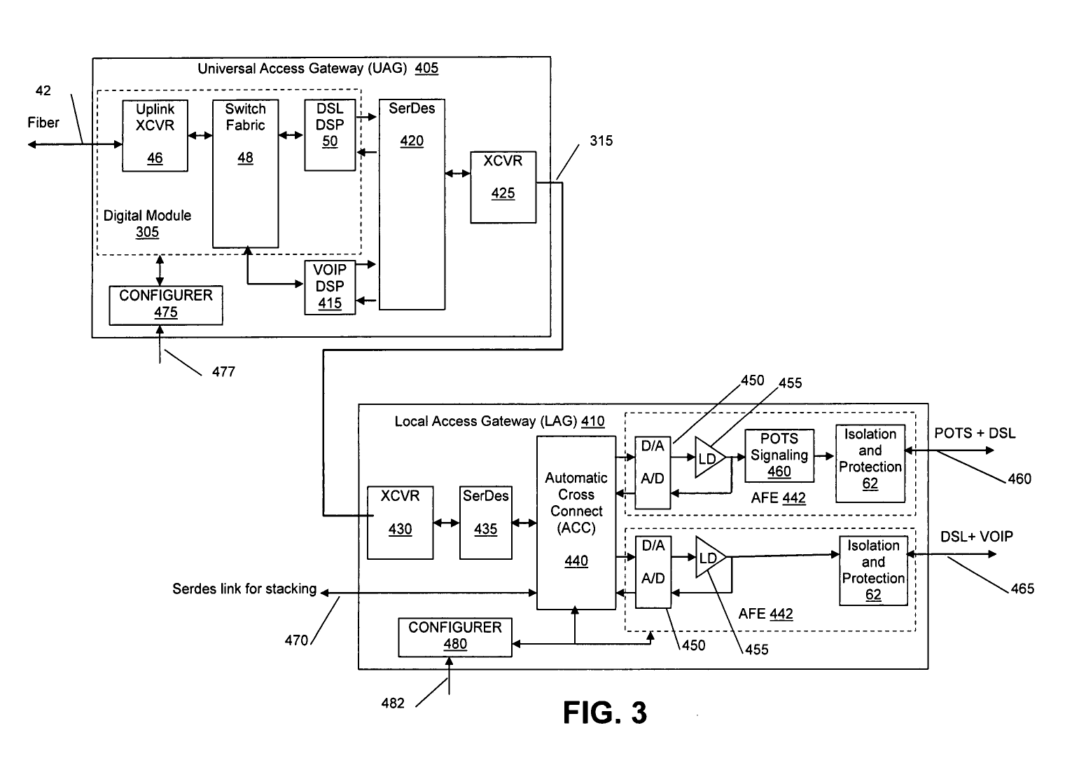

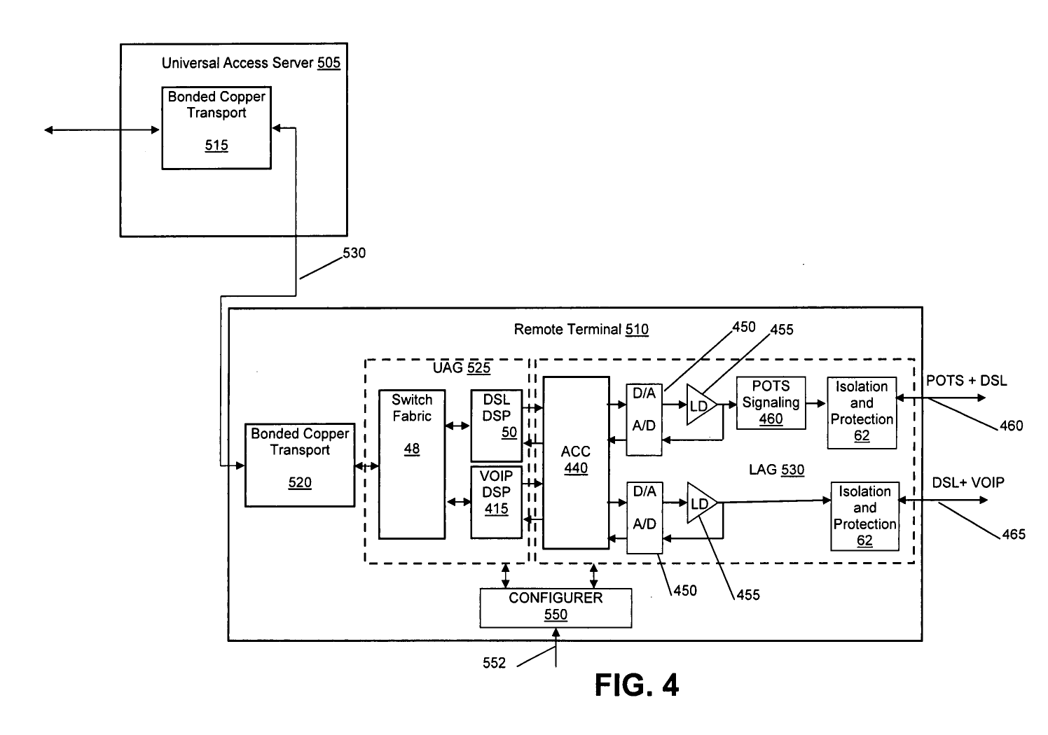

To transport data and/or signals between the digital module 305 and the analog module(s) 310, the example distributed DSLAM of FIG. 2 includes a communication link 315 (e.g., a digital link 315). The communication link 315 may be implemented using any of a variety of suitable data transmission and/or communication technologies, methods and/or communication devices. For example, as described below in connection with FIG. 3, the communication link 315 may be implemented as a broadband communication link comprising a fiber optic cable and fiber optic transceivers. Additionally or alternatively, the communication link 315 may be implemented using bonded copper transport technology (e.g., based on the International Telecommunication Union (ITU) G.998 family of standards), for instance, Ethernet over copper (i.e., ITU G.998.2) as discussed below in connection with FIG. 4.

As discussed above, the digital module 305 may be shared among multiple analog modules 310. In particular, the digital module 305 may communicate with a plurality of analog modules 310 using time-division multiplexing (TDM) for the digital link 315. Having separated the digital module 305 from the analog module(s) 310, the digital module 305 may be implemented anywhere within a communication system and/or network (e.g., it may be remote from the analog module(s) 310). In particular, the digital module 305 and the analog modules 310 may be implemented and/or located together and/or in physically separate and/or in different geographic locations. For example, the digital module 305 may be implemented in a central office and may communicate with a plurality of analog modules 310 located, for example, at one or more SAIs. Alternatively, the digital module 305 and the analog module(s) 310 may be co-located and/or implemented together. Additionally or alternatively, the digital module 305 and one or more analog modules 310 may be implemented in a same housing or in different housings. For example, a digital module 305 may be implemented together with a first analog module 310 in a first housing, while a second analog module 310 is implemented in a second housing. A digital module 305 may be implemented in one housing, and an analog module 310 implemented in a second housing, etc.

The example digital module 305 of FIG. 2 may include more than one DSP 50 to allow the digital module 305 to support additional customers. Further, a service provider may implement a DSLAM containing multiple digital modules 305 and/or multiple digital links 315. For example, the switch fabric 48 may route data received via the uplink XCVR 46 based on an address associated with each digital module 305 and/or each DSP 50. For example, each DSP 50 may be assigned an Internet Protocol (IP) address, Ethernet may be used as the transmission protocol for the fiber optic link 41, and/or the switch fabric 48 may implement a multi-port Ethernet switch using any of a variety of techniques.

In the illustrated example of FIG. 2, the DSPs 50 may be statically and/or dynamically assigned to the analog module(s) 310. For instance, one DSP 50 may be assigned to one or more analog modules 310 located in a first SAI, while a second DSP 50 is assigned to one or more analog modules 310 located in a second SAI. Alternatively or additionally, each analog module 310 may be assigned to a DSP 50 and/or to a digital module 305 when an initial DSL service provided by the analog module 310 is configured and/or provisioned to provide the service. In this fashion, digital modules 305 may be deployed and/or installed as demand for DSL services increases and, thus, more efficiently share digital module 305 and/or DSP 50 resources across a larger number of analog modules 310. For example, an analog module 310 may be installed and physically connected to each telephone line served by a SAI. When a service is requested on a telephone line, the analog module 310 for that telephone line may be appropriately configured and assigned to a digital module 305 based on any of a variety of business constraints or other criteria. For example the DSP 50 having the lowest current load and/or utilization could be selected, the DSP 50 could be selected upon the type of the requested DSL service, etc.

In the illustrated example of FIG. 2, the digital link 315 is implemented using TDM techniques. In particular, when an analog module 310 is associated with and/or assigned to a digital module 310, one or more time slots on the digital link 315 are assigned to the analog module 310 and to the digital module 305. The analog module 310 uses the assigned time slots on the digital link 315 to exchange data with the digital module 305. It will be readily apparent to persons of ordinary skill in the art that alternative techniques may be used to implement the digital link 315. For example, the digital link 315 may be implemented using any of a variety of packet based communication techniques, for example, Ethernet.

FIGS. 3 and 4 illustrate additional example distributed DSLAMs constructed in accordance with the teachings of the invention. Some components of the example distributed DSLAM of FIG. 2 are the same as or substantially similar to corresponding components in the example distributed DSLAMs of FIGS. 3 and 4. In the interest of brevity, the descriptions of these corresponding elements, devices, circuits and/or components will not be repeated in connection with the description of the examples of FIGS. 3 and 4. Instead, the interested reader is referred back to the corresponding descriptions discussed above in connection with FIG. 2. To facilitate this process, corresponding elements in FIGS. 2-4 have been numbered with like reference numerals.

The example distributed DSLAM of FIG. 3 is partitioned into at least one universal access gateway (UAG) 405 and at least one local access gateway (LAG) 410. In the example distributed DSLAM of FIG. 3, the UAG 405 includes one or more digital modules 305, and the LAG 410 includes at least one analog interface 442 (i.e., an analog front end 442, for example, the analog module 310).

To support Voice over IP (VoIP), the example UAG 405 of FIG. 3 includes at least one VoIP DSP 415 in addition to at least one DSL DSP 50. The VoIP DSP 415, using any of a variety of techniques, converts data representative of digitized voice and/or audio into IP packets containing the digitized voice and/or audio that may be transmitted, for example, within a DSL service provided to a customer.

In the example DSLAM of FIG. 3, the uplink transceiver 46 may receive and transmit packets of information via the fiber link 42. The packets of information may include digitized voice, digitized video, alphanumerical data such as documents and files, instant messaging, text messaging, and any other information and/or data. When information and/or data is received via the fiber link 42, the uplink transceiver 46 provides the information to the switch fabric 48, which may determine whether the information and/or data represents digitized voice by, for example, examining packet header information. If the information contains digitized voice, then the digitized voice may be provided to the VoIP DSP 415. If the information contains non-voice information, it is provided to the DSL DSP 50.

To form a digital stream that may be transported across the digital link 315 to one or more of the LAGs 410, the example UAG 405 of FIG. 3 includes any of a variety of serializer/deserializer (SerDes) devices 420. The SerDes device 420, using any of a variety of techniques, receives data from the one or more DSPs 50, 415 and serializes the data into one or more timeslots associated with the digital link 315. The transceiver 425 then transmits the serialized data stream across the digital link 315 to one or more of the LAGs 410. Similarly, the transceiver 425 receives a serialized data stream from the digital link 315 and the SerDes device 420 de-serializes the stream and passes data to an appropriate DSP 50, 415.

To remotely configure the example UAG 405 of FIG. 3 from, for example, an operations center, the UAG 405 includes a configurer 475. The example configurer 475 of FIG. 3 receives remote commands and/or control signals (e.g., electromagnetic signals) via the fiber optic link 42 and/or an external communications path 477. For example, for commands received via the fiber optic link 42, the configurer 475 could be assigned an IP address such that commands can be transmitted to the configurer 475 in IP packets and automatically routed to the configurer 475 via the switch fabric 48. The external path 477 may be formed using any of a variety of techniques, for example, a first modem attached and/or a part of the UAG 405 and a second modem at an operations center. Based upon information, parameters and/or variables contained in the commands and/or control signals, the configurer 475 configures the digital module 305, the VoIP DSP 415 and/or any LAGs 410 to which the UAG 405 is communicatively coupled. For instance, the configurer 475 could instruct one of the DSPs 50, 415 to send command and/or control information to the LAG 410 via the SerDes device 420 and the communication link 315.

To receive data from, and to transmit data to, a UAG 405, the example LAG 410 of FIG. 3 includes a transceiver 430 and a SerDes device 435. The implementation and operation of the transceiver 430 and the SerDes device 435 are similar to those described above in connection with the UAG 405. In the illustrated example of FIG. 3, the digital link 315 is a broadband link implemented using a fiber optic link or a repeatered copper link (i.e., a series of copper cable connections and signal repeaters), wireless connection and/or other broadband links.

To route and/or switch data received via the digital link 315, the example LAG 410 of FIG. 3 includes a switch interface 440 (e.g., an Automated Cross Connect (ACC) 440). Based upon, for example, an assigned timeslot on the digital link 315, the switch interface 440 routes received data associated with a DSL modem to a particular analog front end (AFE) 442 (e.g., to a specific digital/analog converter 450 and LD 455 etc.). Likewise, the ACC 440 routes data received by an AFE 442 into a particular timeslot on the digital link 315. In the illustrated example of FIG. 3, the switch interface 440 may be statically and/or dynamically configured to route data to DSL modems (i.e., the AFEs 442).

Data received by the ACC 440 for a customer may include digitized voice, digitized video, alphanumerical data such as documents and files, instant messaging, text messaging, and any other information and/or data that is to be transmitted to the customer. For example, data for a first customer may represent both a downstream DSL signal and digitized voice (e.g., POTS signals) while data for a second customer may represent a downstream DSL signal containing packetized voice. To convert the digital data received by the ACC 440 into analog signals, the example LAG 410 includes one or more analog/digital converters 450 and one more line drivers 455 (i.e., one or more AFEs 442).

In the example LAG 410 of FIG. 3, the AFEs 442 are capable to simultaneously convert and/or combine both POTS signals and DSL signals. The analog/digital converters 450 and the line drivers 445 include, among other things, a subscriber line interface circuit (SLIC) and/or equivalent functionality. In an example, an output 460 contains both DSL signals residing, for example, above 20 kHz as well as POTS signals residing, for example, below 3 kHz, thus, eliminating the need for a POTS splitter (i.e., POTS+DSL). To provide standard POTS signaling, the example LAG 410 of FIG. 3 also includes one or more POTS signaling circuits 460. In a second example, an output 465 of the LAG 410 contains only DSL signals. In such an example, any voice data will be transported as packets by the DSL service (i.e., DSL+VOIP). While the example LAG 410 of FIG. 3 does not illustrate a POTS signaling circuit 460 for the output 465, persons of ordinary skill in the art will readily recognize that a POTS signaling circuit 460 may be implemented for each DSL modem, and that the POTS signaling circuit 460 may be bypassed and/or disabled when not required. Information received from a customer is processed by a LAG 410 and the UAG 405 using techniques similar to those described above.

As illustrated in FIG. 3, the ACC 440 may additionally provide a SerDes output 470 to allow multiple LAGs 410 to be stacked (i.e., co-located) and/or connected to one or more UAGs 405 via a shared digital link 315.

In the illustrated example of FIG. 3, remote command signals may be sent from a server or any other suitable device, including a PDA, GUI, mobile telephone, computer workstation operations database, etc. via any suitable communication link, (including the Internet) to connect or disconnect any port (e.g., an analog front end) of a LAG 410 from its respective telephone line. For example, an analog/digital converter 450 and line driver 455 pair may be disabled to disconnect services for a customer via a remote command signal. Similarly, remote command signals may be used to, for example, configure the analog/digital converter 450 and line driver pair 455 to support either POTS+DSL or DSL+VoIP.

To remotely configure the example LAG 410 of FIG. 3, the LAG 410 includes a configurer 480. The example configurer 480 of FIG. 3 receives remote commands and/or control signals (e.g., electromagnetic signals) via the communication link 315 and/or an external communications path 482. For example, commands could be received using one or more timeslots of the communication link 315 such that commands can be routed to the configurer 480 by the switch interface 440. The external path 482 may be formed using any of a variety of techniques, for example, a first modem attached and/or a part of the LAG 410 and a second modem at an operations center. Based upon information, parameters and/or variables contained in the commands and/or control signals, the configurer 480 configures the switch interface 440 and the AFEs 442.

In the illustrated example of FIG. 3, the UAG 405 and the LAGs 410 may be implemented and/or located together and/or in physically separate and/or in different geographic locations. For example, the UAG 405 may be implemented in a central office and may communicate with a plurality of LAGs 410 located, for example, at one or more SAIs. Alternatively, the UAG 405 and the LAG(s) 410 may be co-located and/or implemented together. Additionally or alternatively, the UAG 405 and one or more LAGs 410 may be implemented in a same housing or in different housings. For example, a UAG 405 may be implemented together with a first LAG 410 in a first housing, while a second UAG 405 is implemented in a second housing; a UAG 405 may be implemented in one housing, and an LAG 410 implemented in a second housing; etc.

FIG. 4 illustrates another example distributed DSLAM constructed in accordance with the teachings of the invention. The example distributed DSLAM of FIG. 4 includes a universal access server (UAS) 505 and a remote terminal (RT) 510. In the illustrated example of FIG. 4, the RT 510 includes a UAG 525 and at least one LAG 530, and the UAS 505 and the RT 510 communicate via Ethernet over copper technology (e.g., according to the ITU G.998.2 standard). In particular, the UAS 505 and the RT 510 both include a bonded copper transport circuit 515, 520. The operations of the remaining portions of FIG. 4 are similar and/or identical to those described above in connection with FIG. 3 and, thus, in the interest of brevity, a description of those operations will not be repeated here. Instead, the interested reader is referred to the corresponding description of FIG. 3. To facility this process, like portions of FIGS. 3 and 4 are identified with identical reference numerals.

To remotely configure the RT 510, the RT 510 includes a configurer 550. The example configurer 550 of FIG. 4 receives remote commands and/or control signals (e.g., electromagnetic signals) via an Ethernet over copper communication link 530 and/or an external communications path 552. For example, for commands received via the Ethernet over copper communication link 530 the configurer 550 could be assigned and IP address such that commands can be transmitted to the configurer 550 in IP packets and automatically routed to the configurer 550 via the switch fabric 48. The external path 552 may be formed using any of a variety of techniques, for example, a first modem attached and/or a part of the RT 510 and a second modem at an operations center. Based upon information, parameters and/or variables contained in the commands and/or control signals, the configurer 550 configures the UAG 525 and the LAGs 530.

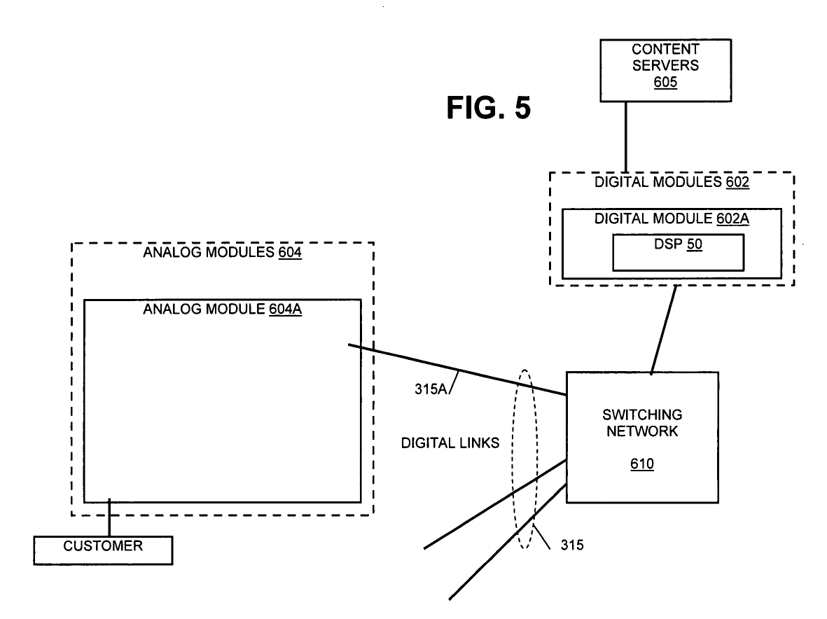

FIG. 5 illustrates mapping, cross-switching and/or cross-connecting one or more telephone lines to one or more signal processing modules thereby providing, for example, a DSL service to one or more telephone lines. As described above, a communication system and/or network may include one or more broadband content servers 605, one or more digital modules 602 (e.g., digital modules 305, UAGs 405 or UASs 505), a switching network 610, and one or more analog interfaces 604 (e.g., analog modules 310, LAGs 410 or RTs 510).

To connect a particular one of the digital modules 602A to a particular one of the analog modules 604A, the example system of FIG. 5 includes a switching network 610. The switching network 610 may be implemented using any of a variety of techniques and/or devices. For example, the switching network 610 may be implemented as a TDM cross-connect, a packet-based switched network, etc. For instance, the switching network 610 may be configured to connect a digital module 602A to an analog module 604A via a time slot of a digital link 315A. Alternatively, the switching network 610 could use, for example, an IP address of an IP packet to route data between the digital module 602A and the analog module 604A.

It will be readily apparent to persons of ordinary skill in the art that the illustrated examples of FIGS. 2-5 may be utilized, combined and/or augmented to implement a distributed DSLAM in any of a variety of ways. For example, a UAG 405 located in a central office may connect to a LAG 410 located at a SAI, a UAG 405 located in a central office may connect to a first LAG 410 located at a first SAI via a second LAG 410 located at a second SAI, a UAG 405 and a LAG 410 may be co-located in a central or serving office, a UAS 505 located in a central office may connect to a RT 510 located at a SAI. By reviewing the above examples, other additional examples will abound to persons of ordinary skill in the art.

It will also be readily apparent to persons of ordinary skill in the art that the example analog module 310, the example LAG 410 and/or the example RT 510 may be implemented to have low power consumption and, thus, be line powered. That is, they may obtain power provided by a central office via, for example, a copper wire or a fiber optic cable. For example, when a LAG 410 is located in a SAI the LAG 410 may be substantially closer to the customer than if the LAG 410 were located in a central office. Thus the line driver may need to provide substantially less amplification, thereby consuming considerably less power.

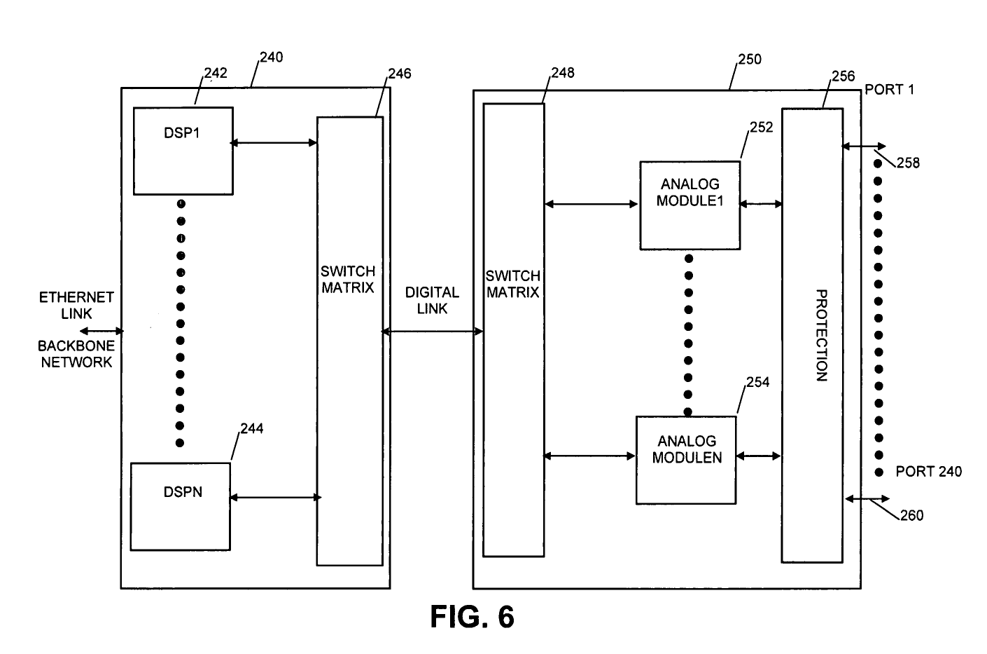

FIG. 6 is yet another example manner of implementing a distributed DSLAM constructed in accordance with the teachings of the invention. Like the illustrated examples of FIG. 2-4, the example distributed DSLAM of FIG. 6 may be implemented as more than one distinct and/or distributed components 240 and 250. In particular, the illustrated example of FIG. 6 includes a plurality of DSPs (e.g., DSP1 242 through DSPN 244) each of which is coupled to a network (such as the Internet) via an Ethernet link or a backbone network and provide services for a plurality of customers. Each of the plurality of DSPs may be configured differently, and each may be coupled to provide one or more services to a group of customers.

To connect the plurality of DSPs to, for example, a plurality of analog interfaces (i.e., analog modules), the example DSLAM of FIG. 6 includes a first switch interface (e.g., a switch matrix 246) and a second switch interface (e.g., a switch matrix 248) that implement a many-to-many digital switched network that may, for example, include dedicated switched connections, multiplexed signals, and/or addressed packets. Other possible implementations for the switch matrices 246 and 248 include, but are not limited to, CDMA and TDMA protocols. Encryption and frequent updating of routing, encryption keys and/or IP addresses may be used to prevent a customer from obtaining services that the communications company and/or service provider has not assigned to the customer.

To transmit signals to and receive signals from a plurality of subscribers, the component 250 includes, for example, the plurality of analog modules (e.g., analog modulel 252 through analog moduleN 254). In the illustrated example of FIG. 6, each of the plurality of analog modules is associated with respective ones of a plurality of subscribers.

As illustrated and discussed above in connection with FIGS. 2-6, a distributed DSLAM may be implemented in any of a variety of manners. In particular, a distributed DSLAM implementation may be chosen based upon one or more design and/or deployment criteria. For example, the UAG 405 and the LAG 410 may be co-located or remote from each other, the communication link 315 may be implemented to have different speeds and/or a different type, an implementation and/or type of analog front end 442 (e.g., DAC conversion speed), etc. Having reviewed the disclosed example distributed DSLAM implementations illustrated in FIGS. 2-6, a person of ordinary skill in the art will recognize that other examples abound.

In the illustrated example distributed DSLAMs of FIGS. 2-4 and 6, none of the example digital module 305, the example UAG 405 or the example component 240 contain a digital/analog converter 54, 450, a DAC 56, an ADC 58, a LD 60, 455, a POTS splitter 64 or an isolation and protection circuit 62. Similarly, the example analog modules 310 and the LAGs 410 of FIGS. 2-4 and 6 do not include a signal processing device (e.g., the DSP 50, 415).

It will be readily apparent to persons of ordinary skill in the art that a distributed DSLAM may contain any of a variety of additional devices, components and/or functionality beyond those shown and discussed herein. For example, a distributed DSLAM may include any or all of a management and/or monitoring processor, a FLASH memory device, four-wire to two-wire hybrid circuits, etc. In the interest of brevity and clarity, such elements are not discussed herein. However, it is assumed that any such appropriate devices may be implemented by and/or within any distributed DSLAM.

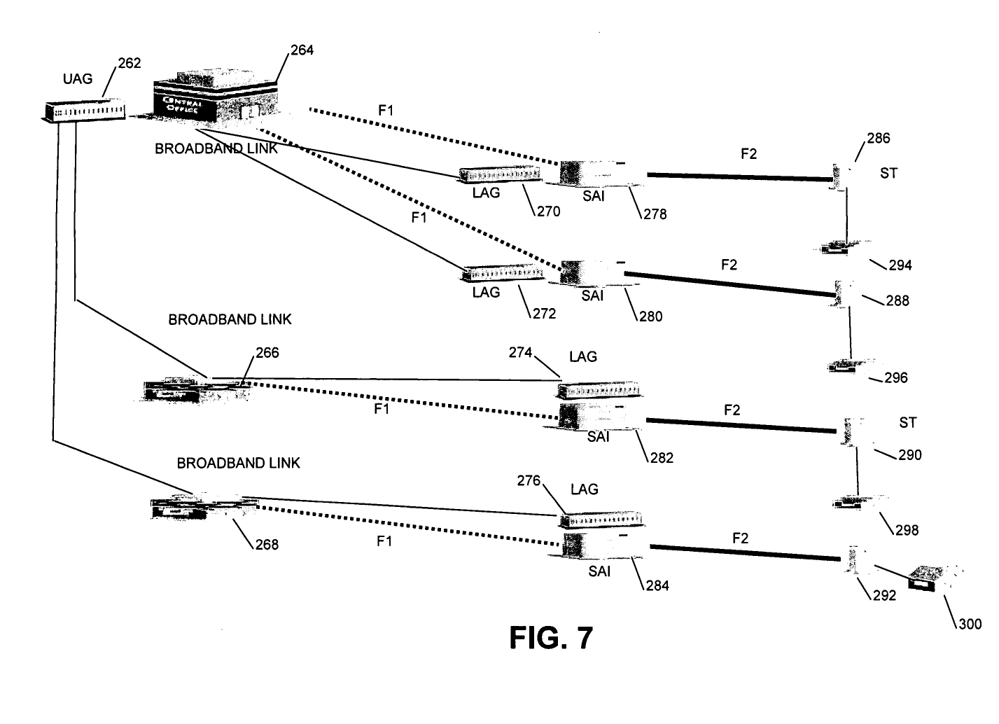

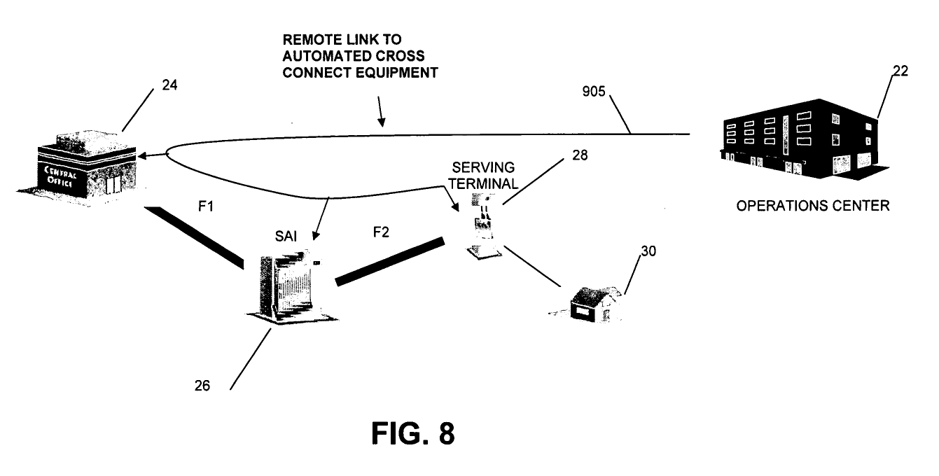

FIGS. 7 and 8 are schematic illustrations of example communication systems constructed in accordance with the teachings of the invention. The example system of FIG. 7 illustrates a UAG 262 associated with a central office 264 that is coupled to one or more LAGs 270 and 272 located at one or more SAIs 278 and 280, respectively, via at least one broadband digital link. The UAG 262 is further coupled via second and third central and/or serving offices 266 and 268 to LAGs 274 and 276, respectively. In the example illustrated in FIG. 7, the UAG 262 and the LAGs 278, 280, 282 and 284 are configured such that the UAG 262 may provide services to a plurality of customers 294, 296, 298 and 300 via a respective plurality of serving terminals 286, 288, 290 and 292.

In contrast to the example prior art system of FIG. 1, the example system of FIG. 8 incorporates one or more distributed DSLAMs and implements a remote link 905 between the operations center 22, the central office 24, the SAI 26 and the ST 28. The remote link 905 can be used, for example, to remotely command and/or configure a UAG 305 and switching network 222 installed in the central office 24 and a LAG 310 installed in the SAI 26, thereby eliminating a truck roll to configure a service for the customer 30.

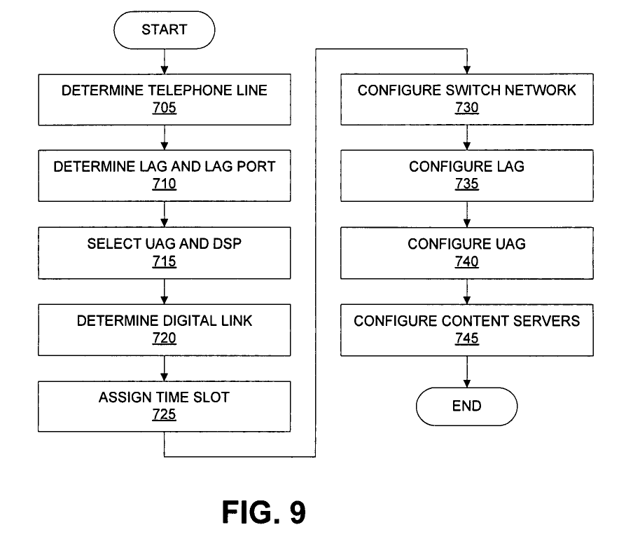

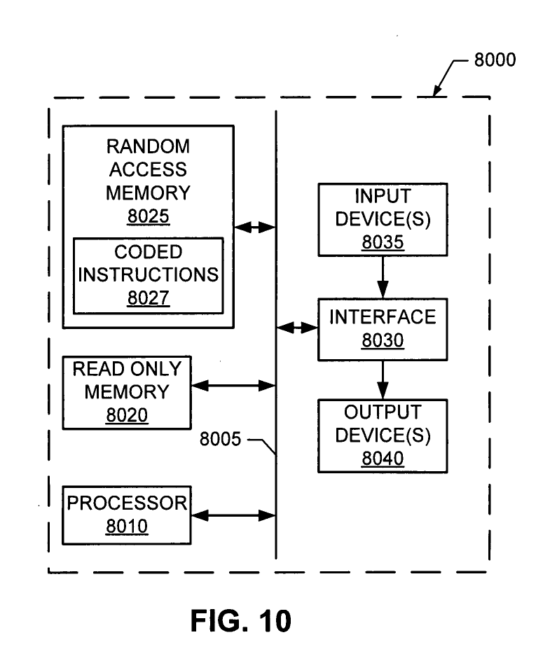

FIG. 9 illustrates a flowchart representative of example machine readable instructions that may be executed to configure the example distributed DSLAMs and/or the example systems of FIGS. 2-8. The example machine readable instructions of FIG. 9 may be executed by a processor, a controller and/or any other suitable processing device. For example, the example machine readable instructions of FIG. 9 may be embodied in coded instructions stored on a tangible medium such as a flash memory, or RAM associated with a processor (e.g., the processor 8010 shown in the example processor platform 8000 and discussed below in conjunction with FIG. 10). Alternatively, some or all of the example machine readable instructions of FIG. 9 may be implemented using an application specific integrated circuit (ASIC), a programmable logic device (PLD), a field programmable logic device (FPLD), discrete logic, hardware, firmware, etc. Also, some or all of the example machine readable instructions of FIG. 9 may be implemented manually or as combinations of any of the foregoing techniques, for example, a combination of firmware and/or software and hardware. Further, although the example machine readable instructions of FIG. 9 are described with reference to the flowcharts of FIG. 9, persons of ordinary skill in the art will readily appreciate that many other methods of configuring the example distributed DSLAMs and/or the example systems of FIGS. 2-8 may be employed. For example, the order of execution of the blocks may be changed, and/or some of the blocks described may be changed, eliminated, sub-divided, or combined.

Execution of the example machine readable instructions of FIG. 9 by, for example, a processor 8010 begins, for instance, in response to a customer requesting a new communication service (e.g., VoD via DSL). Persons of ordinary skill in the art will appreciate that, although for simplicity of illustration and discussion, the flowchart of FIG. 9 shows one control path, requests may be queued and processed sequentially and/or processed in parallel by, for example, separate processing threads. The processor 8010 first determines the telephone line associated with the customer (i.e., connected to the customer's location) (block 705) and then determines, for example, the LAG 310 and the LAG 310 port (i.e., the analog interface and/or analog front end) connected to the telephone line (block 710). Next, using any of a variety of criteria, the processor 8010 selects a DSP 50 and a UAG 305 to provide the service (block 715), determines a digital link 315 connecting the LAG 310 and the selected DSP 50 (block 720), and selects and/or assigns a timeslot of the digital link to the customer (block 725). Based on the assigned timeslot and selected digital link 315, the processor 8010 configures, for example, the switch network 222 to transport the assigned timeslot between the UAG 305 and the LAG 310 (block 730). The processor 8010 then configures the LAG 310 based upon one or more parameters associated with the requested service (e.g., DSL+POTS vs. DSL+VoIP, etc.) (block 735), configures the UAG 305 (block 740) and configures the broadband content servers (block 745).

FIG. 10 is a schematic diagram of an example processor platform 8000 that may be used and/or programmed to implement the example machine readable instructions illustrated in FIG. 9 to configure the example DSLAMs and/or the systems of FIGS. 2-8. For example, the processor platform 8000 can be implemented by one or more general purpose microprocessors, microcontrollers, etc.

The processor platform 8000 of the example of FIG. 10 includes a general purpose programmable processor 8010. The processor 8010 executes coded instructions 8027 present in main memory of the processor 8010 (e.g., within a random access memory (RAM) 8025). The processor 8010 may be any type of processing unit, such as a microprocessor from the Intel®, AMD®, IBM®, or SUN® families of microprocessors. The processor 8010 may implement, among other things, the machine readable instructions of FIG. 9 to configure the example DSLAMs and/or the examples systems of FIGS. 2-8.

The processor 8010 is in communication with the main memory (including a read only memory (ROM) 8020 and the RAM 8025) via a bus 8005. The RAM 8025 may be implemented by dynamic random access memory (DRAM), Synchronous DRAM (SDRAM), and/or any other type of RAM device. The ROM 8020 may be implemented by flash memory and/or any other desired type of memory device. Access to the memory 8020 and 8025 is typically controlled by a memory controller (not shown) in a conventional manner.

The processor platform 8000 also includes a conventional interface circuit 8030. The interface circuit 8030 may be implemented by any type of well-known interface standards, such as an external memory interface, serial port, general purpose input/output, etc. One or more input devices 8035 and one or more output devices 8040 are connected to the interface circuit 8030.

Of course, persons of ordinary skill in the art will recognize that the order, size, and proportions of the memory illustrated in the example systems may vary. Additionally, although this patent discloses example systems including, among other components, software or firmware executed on hardware, it will be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, persons of ordinary skill in the art will readily appreciate that the above described examples are not the only way to implement such systems.

At least some of the above described example methods and/or apparatus are implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of the invention are not limited to such devices, standards and/or protocols. For instance, DSL, POTS, VoIP, IP, Ethernet over Copper, fiber optic links, DSPs, G.998.2 represent examples of the current state of the art. Such systems are periodically superseded by faster or more efficient systems having the same general purpose. Accordingly, replacement devices, standards and/or protocols having the same general functions are equivalents which are intended to be included within the scope of the accompanying claims.

Although certain example methods, apparatus and articles of manufacture have been described herein, the scope of coverage of this patent is not limited thereto. On the tent covers all methods, apparatus and articles of manufacture fairly falling of the appended claims either literally or under the doctrine of equivalents.

What is claimed is:

1. A module of a distributed digital signal line (DSL) access multiplexer (DSLAM), the module comprising:
a signal processing device configurable to process a DSL signal to be routed to an analog interface associated with a subscriber line, the analog interface being physically separate from the module, wherein the analog interface is to connect to a first end of the subscriber line that is terminated at the other end by a DSL modem; and
a communication device to communicate the DSL signal from the signal processing device to the analog interface.

2. A module as defined in claim 1,
wherein the signal processing device is configurable to process a second DSL signal to be routed to a second analog interface associated with a second subscriber line, the second analog interface physically separate from at least one of the module or the analog interface; and
wherein the communication device is to communicate the second DSL signal from the signal processing device to the second analog interface.

3. A module as defined in claim 2, wherein the module is located in at least one of a central office or a serving office, wherein the analog interface is located in a serving area interface and wherein the second analog interface is located in a second serving area interface.

4. A module as defined in claim 1, wherein the module does not contain a digital to analog converter.

5. A module as defined in claim 1, wherein the module does not contain a plain old telephone service (POTS) splitter.

6. A module as defined in claim 1, wherein the communication device is at least one of a serializer/deserializer device, a transceiver, or a bonded copper transport device.

7. A module as defined in claim 1, further comprising:
a second signal processing device;
a transceiver to receive service content from a content server; and
a switch fabric to route the service content to one of the signal processing devices based on a parameter associated with the service content.

8. A module as defined in claim 7, wherein the parameter is an Internet Protocol (IP) address.

9. A module as defined in claim 1, wherein the module is located in at least one of a central office or a serving office and wherein the analog interface is located in a serving area interface.

10. A module as defined in claim 1, wherein the signal processing device is a digital signal processor (DSP).

11. A module as defined in claim 1, wherein the signal processing device is a bonded copper transport device and wherein the communication interface is a transceiver.

12. A module as defined in claim 1, wherein the DSL signal is to provide at least one of a voice over the internet protocol (VOIP) service, an internet protocol-based television (IPTV) service, or a video-on-demand (VoD) service.

13. A module as defined in claim 1, further comprising a second signal processing device to convert at least one of digitized voice or digital audio signals into internet protocol (IP) packets.

14. A module of a distributed digital signal line (DSL) access multiplexer (DSLAM), the module comprising:
an analog interface connectable to a subscriber line to provide a DSL service to a respective subscriber, wherein the analog interface is to connect to a first end of the subscriber line that is terminated at the other end by a DSL modem;
a communication device to receive a DSL signal from a second module of the distributed DSLAM, the second module being physically separate from the module; and
a switching interface to route the DSL signal between the communication device and the analog interface, wherein the analog interface is to transmit the DSL signal on the subscriber line.

15. A module as defined in claim 14, wherein the switching interface is at least one of an automated cross-connect or a switch matrix.

16. A module as defined in claim 14, wherein the module does not include a signal processing device to process the DSL signal.

17. A module as defined in claim 14, wherein the analog interface is to receive a second DSL signal from the line, wherein the switching interface is to route the second DSL signal to the communication device, and wherein the communication device is to transmit the second DSL signal to the second module.

18. A module as defined in claim 14, wherein the DSL service is at least one of a voice over the internet protocol (VoIP) service, an internet protocol-based television (IPTV) service, or a video-on-demand (VoD) service.

19. A module as defined in claim 14, wherein the communication device comprises at least one of a serializer/deserializer device, a transceiver or a bonded copper transport device.

20. A module as defined in claim 14, wherein the switching interface is configured in response to a command signal.

21. A module as defined in claim 20, wherein the command signal is transmitted over a communication link communicatively coupled to the communication device.

22. A module as defined in claim 14, wherein the analog interface comprises as least one of a digital-to-analog converter, an analog-to-digital converter, a line driver, a POTS signaling circuit, a subscriber line interface circuit, or an isolation and protection circuit.

23. A module as defined in claim 14, wherein the communication device receives the DSL signal from the second module via a communication link that is at least one of a broadband communication link, a time division multiplexed communication link, a packet based communication link, a wireless link, a fiber optic link, a copper link, an Ethernet link, or an Ethernet over copper link.

24. A distributed digital subscriber line (DSL) access multiplexer (DSLAM) comprising:
a first module comprising at least one signal processing device to process a DSL signal; and
a communication link to transport the DSL signal between the first module and a second module,
wherein the second module comprises:
a plurality of analog interfaces connectable to respective ones of a plurality of lines for providing services to respective ones of a plurality of subscribers; and
a switching interface to route the DSL signal between the communication link and a first one of the plurality of analog interfaces associated with a first one of the plurality of subscribers.

25. A distributed DSLAM as defined in claim 24, wherein the plurality of analog interfaces are to connect to first ends of the plurality of lines terminated at other ends by respective ones of a plurality of DSL modems.

26. A distributed DSLAM as defined in claim 24, wherein the first and second modules are located at different geographic locations.

27. A distributed DSLAM as defined in claim 24, wherein the first module is located at a central office and wherein the second module is located at a serving area interface.

28. A distributed DSLAM as defined in claim 24, wherein the first and second modules are in different housings.

29. A distributed DSLAM as defined in claim 24, wherein the first one of the plurality of analog interfaces is to transmit the DSL signal on a respective one of the plurality of lines and to receive a second DSL signal from the respective one of the plurality of lines, wherein the switching interface is to route the second DSL signal between the first one of the plurality of analog interfaces and the communication link, and wherein the communication link is to transport the second DSL signal between the switching interface and the first module.

30. A distributed DSLAM as defined in claim 24, wherein the plurality of analog interfaces each comprise:
an analog front end; and
an isolation and protection circuit.

31. A distributed DSLAM as defined in claim 24, wherein the communication link is at least one of a broadband communication link, a time division multiplexed communication link, a packet based communication link, a wireless link, a fiber optic link, a copper link, an Ethernet link, or an Ethernet over copper link.

32. A distributed DSLAM as defined in claim 24, wherein the DSL signal represents broadband service content received by the signal processing device from at least one of a content server or a backbone server.

33. A distributed DSLAM as defined in claim 24, wherein the switching interface connects the first module to the second module in response to a command signal transmitted from an operations center.

34. A distributed DSLAM as defined in claim 33, wherein the command signal is transmitted over the communication link.

35. A distributed DSLAM as defined in claim 24, wherein the services includes a service selected from at least one of a digital subscriber line (DSL) service, a voice over the internet protocol (VOIP) service, an internet protocol-based television (IPTV) service, plain old telephone service (POTS), or a video-on-demand (VoD) service.

36. A distributed digital subscriber line (DSL) access multiplexer (DSLAM) comprising:
a first module comprising at least one signal processing device to process DSL signals;
a second module comprising a first plurality of analog interfaces connectable to respective ones of a first plurality of lines for providing services to respective ones of a first plurality of subscribers; and
a third module comprising a second plurality of analog interfaces connectable to respective ones of a second plurality of lines for providing services to respective ones of a second plurality of subscribers, wherein at least one of the second module or the third module is to be located at a different geographic location than the first module.

37. A distributed DSLAM as defined in claim 36, wherein the first and the second plurality of analog interfaces are to transmit DSL signals processed by the first module.

38. A distributed DSLAM as defined in claim 36, wherein the DSL signals represent broadband service content received by the signal processing device from at least one of a content server or a backbone server.

39. A method of configuring a distributed digital subscriber line (DSL) access multiplexer (DSLAM) in response to a request to subscribe, the method comprising:
selecting a digital module of the DSLAM; and
configuring an analog interface of the DSLAM to receive a DSL signal, wherein selecting the analog interface is determined by an identity of a subscriber and wherein the selection of the analog interface does not select the digital module.

40. A method as defined in claim 39, wherein the digital module and the analog interface are located at different geographic locations

41. A method as defined in claim 39, wherein the analog interface may be configured remotely.

42. A method as defined in claim 39, further comprising configuring a signal processing device of the digital module to process the DSL signal.

43. A method as defined in claim 39, further comprising configuring a communication device to route the DSL signal from the analog interface to the digital module via a communications path.

44. A method as defined in claim 39, wherein configuring the analog interface comprises sending a control signal to a switching interface associated with the analog interface.

45. A method as defined in claim 39, wherein selecting the digital module comprises selecting the digital module based on a DSL service type.

46. An article of manufacture storing machine readable instructions which, when executed, cause a machine to:
determine an interface associated with a subscriber;
select a signal processing device to provide a digital subscriber line (DSL) communication service to the subscriber; and
configure a communication path from the selected signal processing device to the interface.

47. An article of manufacture as defined in claim 46, wherein configuring a communication path from the selected signal processing device to the interface comprises sending a control signal to a switching interface associated with the interface.

48. An article of manufacture as defined in claim 46, wherein the communication path is between a central office and a serving area interface location.

49. An article of manufacture as defined in claim 46, wherein determining the interface associated with the subscriber comprises determining an interface that was pre-connected to a subscriber line associated with the subscriber.

50. An article of manufacture as defined in claim 46, wherein selecting the signal processing device to provide the DSL communication service comprises at least one of selecting the signal processing device having a lowest current utilization, or selecting the signal processing device based on a DSL communication service type.

51. A method of establishing a digital subscriber line (DSL) service, the method comprising:
receiving a request to establish a DSL service to a subscriber;
issuing an electromagnetic signal from a first location to a second location to automatically configure an analog module to deliver the DSL service to a line associated with the subscriber.

52. A method as defined in claim 51, further comprising issuing an electromagnetic signal from a first location to at least one of the second location or a third location to automatically configure a digital module to provide the DSL service.

53. A method as defined in claim 52, wherein the third location is remote from at least one of the first location or the second location.

54. A method as defined in claim 51, wherein the second location is remote from the first location.
